(19) United States
(12) Patent Application Publication
(10) Pub. No.: US 2007/0097078 A1
(43) Pub. Date: May 3, 2007

(54) Battery-free wireless optical mouse

(75) Inventor: Chang-Chung Chin, Hsin Tien City (TW)

Correspondence Address: LEONG C LEI, PMB # 1008, 1867 YGNACIO VALLEY ROAD, WALNUT CREEK, CA, 94598, US

(73) Assignee: A-FOUR TECH CO., LTD.

(21) Appl. No.: 11/259,205

(22) Filed: Oct. 27, 2005

(51) Int. Cl. G09G 5/08

(52) U.S. Cl. 345/166

(57) ABSTRACT

A battery-free wireless optical mouse comprises a wireless optical mouse and a mouse pad. This invention is different from the traditional optical mouse is that it is battery-free. It has no power connector and requires no battery. The wireless optical mouse and mouse pad are installed with an electromagnetic inductance coil. The electromagnetic induction generated by the effect of two electromagnetic inductance coils on the wireless optical mouse and mouse pad emits one-way energy capacity to the electromagnetic inductance coil of the wireless optical mouse and provide the necessary power to the optical mouse. The two electromagnetic inductance coils can be adjusted to change the electromagnetic load characteristics, such as electric current load response or frequency response to obtain one-way data transmission purpose. The data are then converted into the proper computer format through the data processing of the mouse and transmitted to the computer.

### BACKGROUND OF THE INVENTION

(a) Technical Field of the Invention

The present invention relates generally to a battery-free, and more particularly to a wireless optical mouse that requires no battery for operation.

The wireless optical mouse and mouse pad are installed with an electromagnetic inductance coil. The electromagnetic induction generated by the effect of two electromagnetic inductance coils on the wireless optical mouse and mouse pad emits one-way energy capacity to the electromagnetic inductance coil of the wireless optical mouse and provide the necessary power to the optical mouse.

The power goes through the voltage protection and regulated power supply to provide power to the wireless optical mouse. The two electromagnetic inductance coils equip with one-way data transmission capability for wireless transmission. The display unit on the mouse pad displays the status of the wireless optical mouse based on the transmitted data.

The two electromagnetic inductance coils can be adjusted to change the electromagnetic load characteristics, such as electric current load response or frequency response to obtain one-way data transmission purpose. The data are then converted into the proper computer format through the data processing of the mouse and transmitted to the computer.

(b) Description of the Prior Art

The traditional wireless mouse system is used to transmit and receive information via radio wave. Generally, a set of transmitter/receiver shall be required to meet the system requirements, of which the transmitter is linked to a wireless mouse, and the receiver is connected to a computer. The wireless mouse is battery-driven. However, given the high frequency operating conditions for external batteries, particularly to extremely high power consumption of photo sensing displacement signal generators, this will lead to higher cost for the end users in replacement of new batteries in a faster pace. Typically, more cost shall be required for the disposal of the waste, as pollution will likely arise when the batteries of wireless optical mouse are disposed.

### SUMMARY OF THE INVENTION

The primary purpose of the present invention is to provide a battery-free wireless optical mouse, which generally comprises a wireless optical mouse and a mouse pad. The wireless optical mouse is equipped with a mouse electromagnetic coil, a coupler, a circuit rectifier, a voltage stabilizer, a mouse controller, a photo sensing displacement signal generator, a circuit modulator, a roller signal generator and a keystroke and the mouse pad with a main electromagnetic coil, an oscillator, a drive, a coupler, a demodulator, a band-pass filter, a comparator, a mouse data processor, a automatic controller and an electronic switch.

The electromagnet coupler of mouse electromagnetic coil obtains electric energy from main electromagnetic coil. After being rectified by the circuit rectifier and regulated by the voltage stabilizer, the electric energy can provide the power required by wireless optical mouse. When the main electromagnetic coil is coupled to the wireless optical mouse, the operating and status information shall be encoded by the mouse controller, then subjected to the modulation or load modulation by the circuit modulator and sent out by means of electromagnetic induction. The data shall be output to the mouse data processor via demodulator, band-pass filter BPF and comparator, then decoded and transmitted to the computer after being converted into the format required by the computer.

The aforesaid battery-free wireless optical mouse has the following features:

During operation, the wireless optical mouse transmits status information, whereby the mouse data processor can control the electromagnetic energy output by main electromagnetic coil.

If the mouse data processor has not received data from wireless optical mouse after a preset time limit, preset minimum electromagnetic energy shall be used to control the output of main electromagnetic coil. For this purpose, either analog or digital output electromagnetic energy is required, of which the digital is suitable for pulse width modulation or frequency modulation or variable-frequency pulse width modulation.

The mouse pad includes a display unit, i.e. LED, for the operating status of wireless optical mouse.

Within the electronics of mouse pad, the oscillation frequency of oscillation circuit unit can be replaced by the output of mouse data converter. The mouse data processor is either a microprocessor incorporating computers data transmission interface or a tailor-made integrated circuit.

The electronic switch is used for on/off of oscillator, with its oscillation frequency output or otherwise not output by a mouse data converter.

The mouse pad includes a keystroke used for wake-up or sleep and wake-up of the mouse pad.

Compatible with USB or PS2 interface for the data transmission interface of the mouse data processor, the power supply of mouse pad can be achieved from USB or PS2.

Additionally, either a power socket or an external power supply is provided for the mouse pad.

The automatic controller is applied to limit the max. output electromagnetic energy of main electromagnetic coil.

The mouse pad and its main electromagnetic coil can be separated from the electronic unit of mouse pad.

During operation, the mouse controller can transmit preset data within every preset time limit.

The main electromagnetic coil is equipped with an adjustable inductor for control of the output energy of main electromagnetic coil.

Also, the wireless optical mouse is equipped with a low-voltage reset unit, which is used to detect the power supply/voltage level, reset the mouse controller and photo sensing displacement signal generator. Alternatively, it firstly can reset the mouse controller, which, then, reset the photo sensing displacement signal generator. Optionally, the low-voltage reset unit can be applied to reset the mouse controller and photo sensing displacement unit as a two-section low-voltage reset unit.

Besides, the wireless optical mouse is provided with an over voltage current distributor, which is used to split the over voltage current from the energy circuit.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows the schematic diagram of the components of the present invention.

FIG. 2 shows the block diagram of the composition of the mouse pad in the first exemplary embodiment.

FIG. 3 shows the block diagram of the wireless optical mouse in the first exemplary embodiment.

FIG. 4 shows the detailed circuit diagram of FIG. 2.

FIG. 5 shows another detailed circuit diagram of FIG. 2.

FIG. 6 shows the detailed circuit diagram of the wireless optical mouse.

FIG. 7 shows the block diagram of the composition of the mouse pad in the second exemplary embodiment.

FIG. 8 shows the detailed circuit diagram of FIG. 7.

FIG. 9 shows the detailed circuit diagram of FIG. 7 after increasing the VCO based on FIG. 2.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

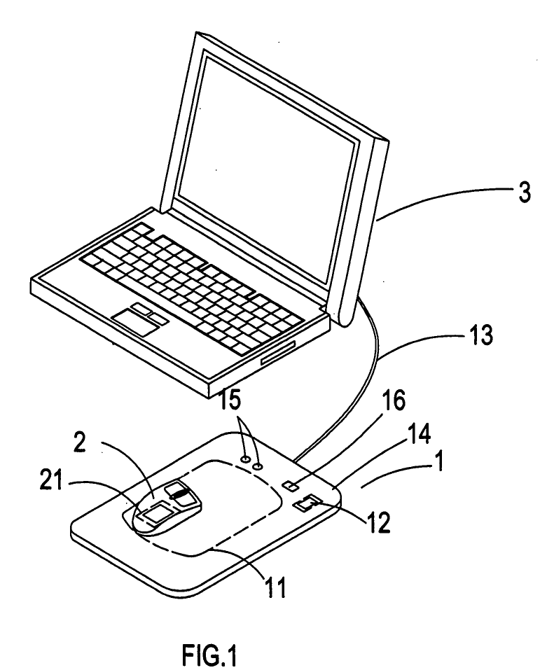

As shown in FIGS. 1-3, the present invention has offered a battery-free wireless optical mouse, which generally comprises a mouse pad 1 and a wireless optical mouse 2.

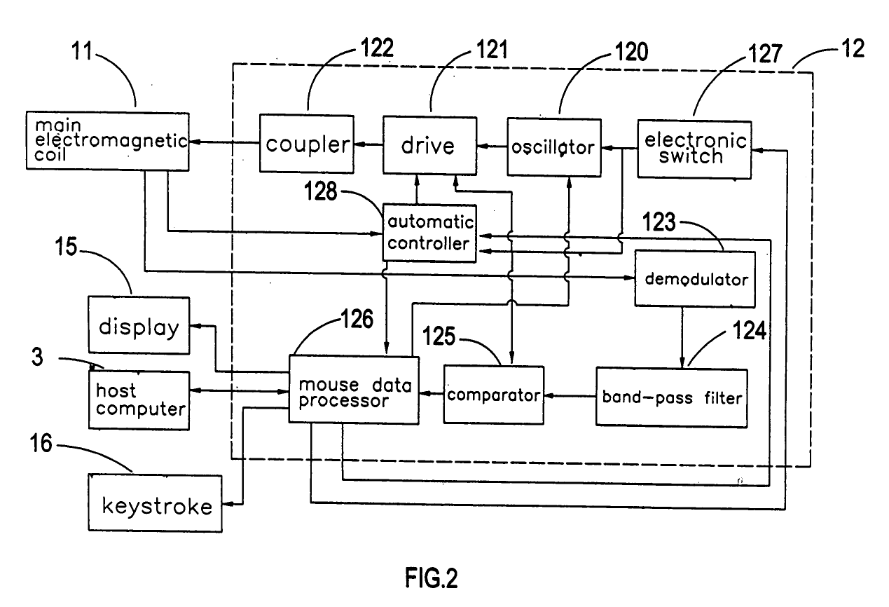

In the first example (as shown in FIG. 2), the mouse pad 1 is composed of a main electromagnetic coil 11, mouse pad's electronic unit 12, a power supply with signal line 13, a mouse pad 14, a display 15 and a keystroke 16. The mouse pad's electronic unit 12 is primarily composed of an oscillator 120, a drive 121, a coupler 122, a demodulator 123, a band-pass filter 124, a comparator 125, a mouse data processor 126 and an electronic switch 127. The electric energy of the mouse pads' electronic unit 12 is obtained by the host computer 3 via power line of signal line 13. As for the electromagnetic energy generated by the mouse pad 1, the oscillator 120 will produce a preset frequency to be activated by the drive 121. And, the electric energy of that frequency is coupled to main electromagnetic coil 11 via a coupler 122.

The wireless optical mouse 2, which requires no power connector and battery, is primarily composed of a mouse electromagnetic coil 21, a circuit rectifier 22, an over voltage current distributor 23, a voltage stabilizer 24, a low-voltage reset unit 25, a circuit modulator 26, a wireless optical mouse body 27 and a coupler 28. To obtain the electric energy required by the wireless optical mouse body 27, the electromagnetic energy of the main electromagnetic coil 11 shall be coupled through the mouse's electromagnetic coil 21, and then subjected to energy coupling of that oscillation frequency by coupler 28. After being rectified by the circuit rectifier 22, the electric energy can provide a stable power for the wireless optical mouse body 27 through over voltage current distributor 23 and voltage stabilizer 24. As such, it is possible to form an operating mode for wireless optical mouse 2 without battery operation. In addition, the wireless optical mouse body 27 is equipped with a mouse controller 271, a photo sensing displacement signal generator 272, a roller signal generator 273 and a keystroke 274.

When the main electromagnetic coil 11 is coupled to the wireless optical mouse 2, the operating and status information of the mouse shall be encoded by the mouse controller 271, then modulated by the circuit modulator 26 and transmitted to main electromagnetic coil 11 by means of electromagnetic induction. With the help of demodulator 123, band-pass filter (BPF) 124 and comparator 125, the data shall be output to the mouse data processor 126, and then transmitted to the computer after being converted into the format required by the computer. So, it is possible to form an operating mode of wireless mouse by which the wireless optical mouse 2 transfers the wireless data.

As the electric energy required by the wireless optical mouse body 27 will set limits on the moving range of wireless optical mouse 2, it is preferable to shift within the range of mouse pad 14. A low-voltage reset unit 25 is used to detect the power supply/voltage level, reset the mouse controller 271 and photo sensing displacement signal generator 272. Alternatively, it can firstly reset the mouse controller 271, which is then used to reset the photo sensing displacement signal generator 272 or enable it to operate. During operation, the mouse controller 271 can transmit preset data within every preset time limit.

During operation of photo sensing displacement signal generator 272, the mouse controller 271 can transmit another data within every preset time limit. Once receiving the preset data, the mouse data processor 126 can control the display 15 showing current state to the users, and control the drive 121 to adjust the energy transmitted by main electromagnetic coil 11 for better power consumption and availability. When the host computer 3 enter a sleep state, or a user activates keystroke 16 to put the mouse into a sleep state, the mouse data processor 126 will turn off the electronic switch 127 after obtaining the aforementioned state, and then enter the energy conservation or sleep mode.

Certainly, either the host computer 3 or the user can activate the keystroke 16 to waken the mouse data processor 126, which will turn on/off the electronic switch 127 for better energy conservation and availability. To protect the mouse pad, the automatic controller 128 will set limits on the max. output electromagnetic energy of main electromagnetic coil.

In case the power line (signal line 13 is not linked to host computer 3, but to USB HUB of BUS POWER or PS2 of host computer 3, there is a possibility of insufficient power for the mouse pad 1. So, external power line may be provided at the power socket of mouse pad 1 to ensure the electric energy of mouse pad 1. The main electromagnetic coil 11 of mouse pad 1 along with mouse pad 14 can be separated from mouse pad's electronic unit 12 for desirable availability.

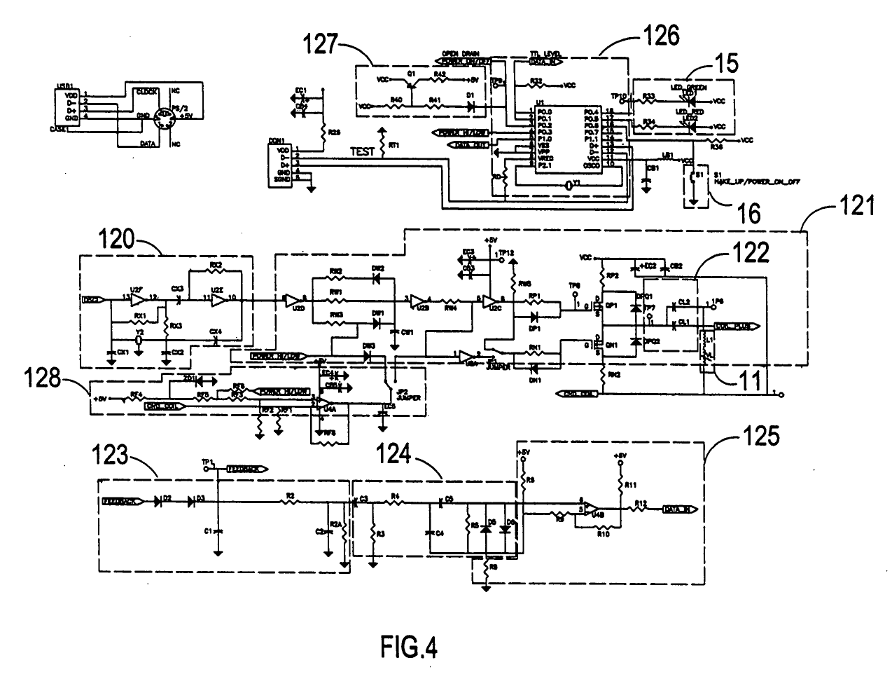

For more information of mouse pad 1 and its overall operating modes, refer to FIG. 4 (also FIG. 2). With a view to the existing oscillating circuit of mouse pad 1, the oscillator 120 is composed of either U2F, U2E, CX3, CX4, RX1, RX2, RX3 and Y2, or U2F, U2E, CX1, CX2, CX3, RX1 and RX3. The oscillator frequency is driven by buffer U2D, then subjected to predrive U2A, U2B, U2C, DP1, DN1, RP1, RN1, RW5, and finally to high-current drive QP1, QN1, RP2, RN2, DPQ1, DPQ2. The above-mentioned elements constitute the drive 121, while CL1 and CL2 form the coupler 122. Then, the electric energy of that frequency shall be coupled to L1 enameled wire to constitute the main electromagnetic coil 11 for single-way transmission of energy. To control the output energy of main electromagnetic coil, an adjustable inductor V1 shall adjust the resonance frequency of main electromagnetic coil, meanwhile the single-way data is received through L1. With the demodulator 123 comprising D2, D3, C1, R2, C2 and R2A, the oscillation frequency of electromagnetic induction can be filtered out. Next, C3, R3, R4, C4, C5, R5, D5 and D6 constitute a band-pass filter 124 in order to filter unnecessary spurious wave. As R6, R8, R9, R10, R11, R12 and U4B constitute a comparator 125, the output signal of band-pass filter can be compared and amplified to output the level required by a microprocessor. As firmware within U1 microprocessor and USB serial data transmission interface constitute a mouse data converter 126, the signal can be output to the computer via the file format of mouse. Moreover, U1 microprocessor is used to control LED1 and LED2 as part of display 15, so the users are aware of the state of battery-free wireless optical mouse. When wireless optical mouse 2 operates beyond the range of wireless optical mouse body 27, the automatic controller 128 enables U1 microprocessor to output a DC level, and controls the pulse width output by oscillator 120 via comparator comprising U4A, RF4, RF5, ZD1, RF6, RF3, RF1, RF2, RF7, RF8 and EC5. In this way, it can reduce the energy of drive 121 for protection and lower power consumption. When the host computer 3 enters sleep mode, download sleep/operating mode via USB serial data transmission interface, or the user can activate keystroke 16 to enter sleep and wake-up mode by pressing S1, then U1 microprocessor will be cut off. Turn offpower switch Q1, R40, R41, R42 and D1 to constitute the power switch 127 and turn it off. Then, switch on oscillating circuit, comparator 125 and automatic controller 128. In case oscillating circuit is switched off, there is little power consumption for the drive. Meanwhile, U1 microprocessor closes the display 15. Some necessary electronic components are included in the circuit herein.

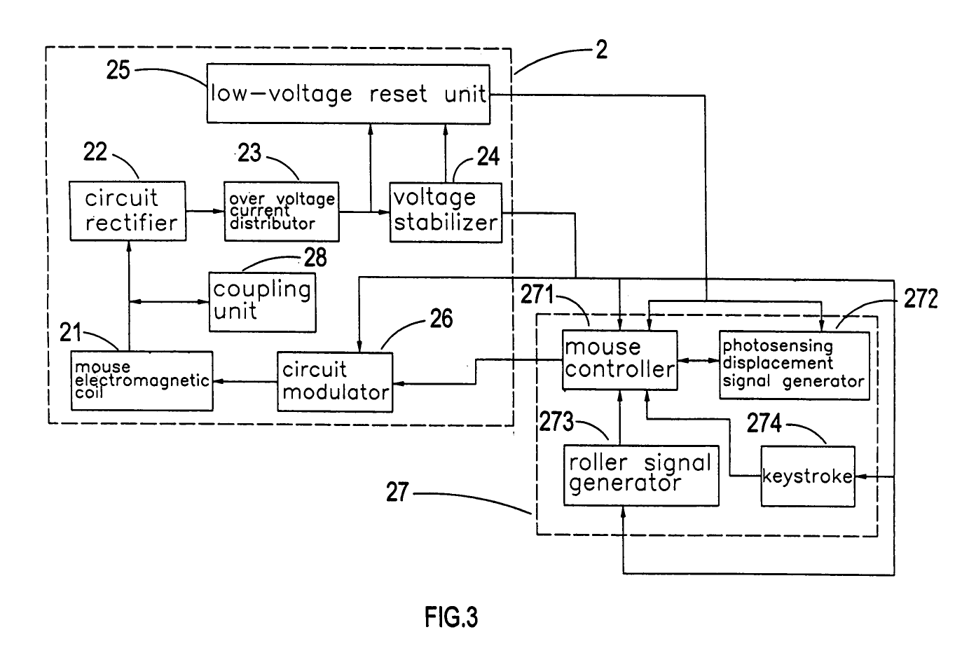

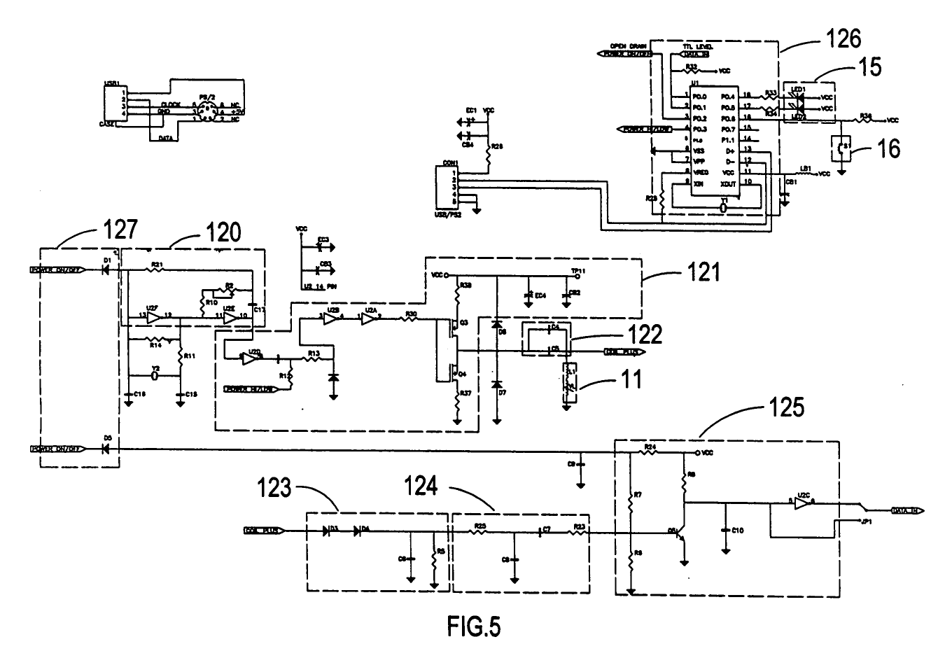

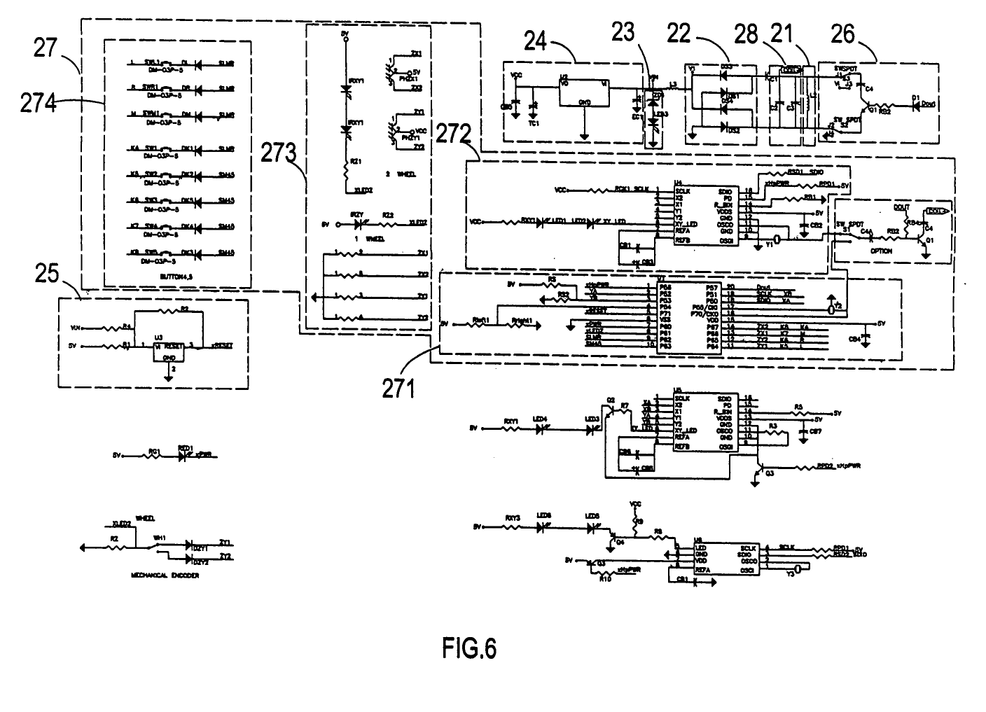

To save the fabrication cost of the circuit of mouse pad 1 shown in FIG. 4, an oscillator 120 may, be constituted by U2F, U2E, R21, R10, R2 and C17 to generate adjustable frequency as also shown in FIG. 5 (another detailed circuit diagram of mouse pad 1). The oscillator frequency is predriven by buffer U2D, U2B and U2A, and then subjected to high-current drive Q3, Q4, R38 and R37. The above-mentioned elements constitute the drive 121. To achieve the desirable power consumption, U1 microprocessor's mouse data processor 126 is used to control the duty period output by R12 in a manner to reduce the energy of drive 121. In the case of sleep or wake-up modes, switch off U1 microprocessor, turn on the power switch D1 to form electronic switch 127, and turn if off. Then, switch on oscillating circuit while D1 can be switched off to save the cost. In such case, there is little power consumption for the drive. The generated oscillator frequency can be directly output by U1 microprocessor and the output duty cycle can be modified to increase or reduce the energy of drive 121, which is generally called pulse width modulation. Alternatively, the oscillator frequency can be directly output by U1 microprocessor and the output frequency can be modified. As coupler 122 is composed of C4 and C5 and the main electromagnetic coil 11 composed of L1 enamelled wire, the frequency displacement can reduce the electromagnetic energy transmitted from L1 main electromagnetic coil 11, thus controlling the output electric energy by variable frequency, which is generally called frequency modulation. Alternatively, U1 microprocessor may be designed with pulse width modulation and frequency modulation to control the electromagnetic energy transmitted from L1 main electromagnetic coil 11, which is generally called variable-frequency pulse width modulation. Also, U1 microprocessor can output a DC level, with this function similar to that of a non-oscillating oscillator that constitutes a virtual electronic switch 127. This example is more cost-efficient because both digital and tailor-made integrated circuit (ASIC) can be applied for mouse data processor 126. For more information of the wireless optical mouse 2 and its overall operating modes, refer to FIG. 6 (also including FIG. 3). The microprocessor 271 specific to the wireless optical mouse body 27 is composed of U1 microprocessor incorporating firmware, the photo sensing displacement signal generator 272 composed of U4, LED1, Y1 and relevant components, the roller signal generator 273 composed of IRZY, RZ2 and relevant components, and keystroke 274 composed of SWL1, SWR1, SWM1, SW1, SW2, SW3, SW4, SW5 and relevant components.

The mouse electromagnetic coil 21 is made of L2 enameled wire, which obtains electromagnetic energy from main electromagnetic coil 11, and is subjected to energy coupling by the coupler 28 of the oscillation frequency. The electric energy is rectified by a rectifier circuit 22 composed of full-wave bridge rectifier circuit DS1, DS2, DS3, DS4. Next, through ZD1 over voltage current distributor 23, ZD1 can realize the results of distributing over voltage and current. Subsequently, the power supply of wireless optical mouse body 27 is sourced from voltage stabilizer 24 of existing EC1, U2, TC1, CB5 and L3. Meanwhile, EC1 is also capable of storing electric energy such that it is possible to offer an operating mode for wireless optical mouse 2 without battery operation.

In the event of operation of wireless optical mouse 2, the operating and status information shall be encoded by the mouse controller 271 of U1 microprocessor, while the energy coupling or load of mouse electromagnetic coil 21 shall be modulated by C4, Q1, RB2 circuit modulator 26. Alternatively, the SW SPDT is switched to J3 and J4 while the energy coupling or load shall be modulated by Vi after DS1, DS2, DS3, DS4 bridge rectification, and finally the data shall be transmitted to the mouse pad 1.

The electric energy required by wireless optical mouse 2 will set limits on the moving range of wireless optical mouse body 27, i.e. within the range of mouse pad 14. For this purpose, a low-voltage reset unit 25 is to detect the power supply/voltage level via existing U3 voltage probe integrated circuit, and reset U1 microprocessor, mouse microprocessor 271. Furthermore, preset data can be transmitted by U1 microprocessor's photo sensing displacement signal generator 272, mouse microprocessor 271, and U1 microprocessor firmware within every preset time limit.

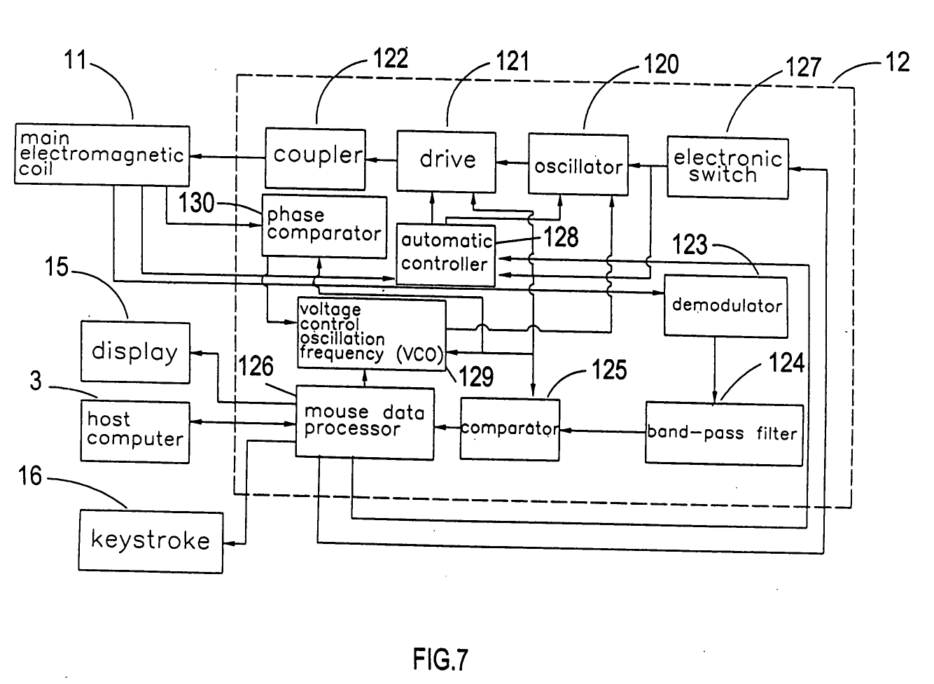

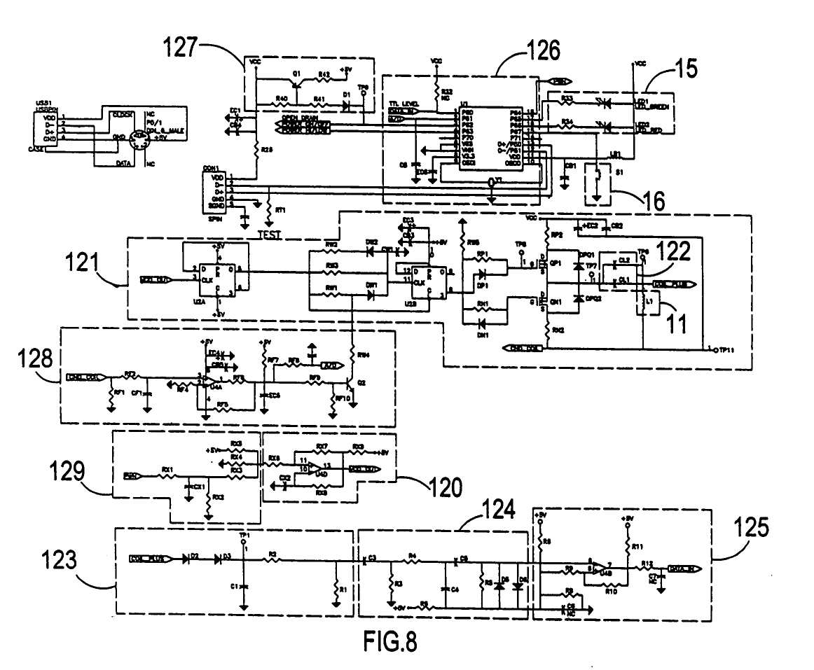

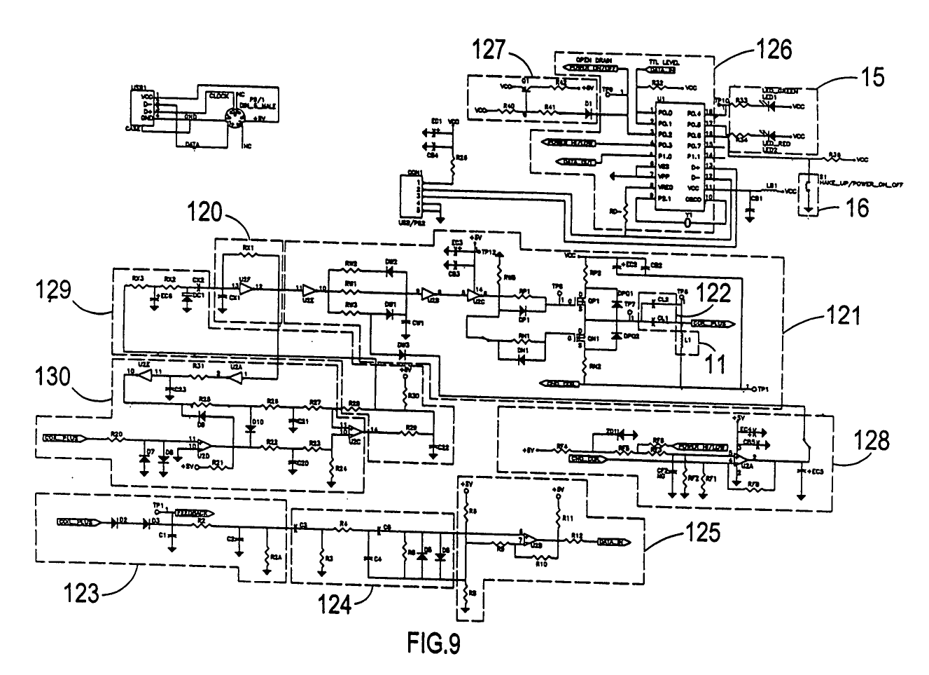

The following is another internal block diagram of the second example (i.e. FIG. 7) that shows how to optimize the power consumption of mouse pad 1 and make it more stable in data transmission. As compared to the internal block diagram of the first example, the mouse pad 1 is also equipped with voltage control oscillation frequency VCO 129 and phase comparator 130, while oscillator 120 of the mouse pad 1 is provided with an integral frequency eliminator to control the energy output of main electromagnetic coil 11. The frequency of oscillator 120 is several times of the resonance frequency of main electromagnetic coil 11. The voltage control oscillation frequency VCO 129 controls the oscillation frequency through voltage, and the oscillation frequency of main electromagnetic coil 11 is obtained from integral frequency eliminator so as to control the energy output of main electromagnetic coil 11, i.e. the mode of feedback of energy output for main electromagnetic coil (refer to FIG. 9). This can be achieved jointly through electronic switch 127, automatic controller 128 (automatic controller 128 is equipped with a unit to detect the energy of main electromagnetic coil), oscillator 120, voltage control oscillation frequency (VCO) 129 and mouse data processor 126. Alternatively, it can be achieved jointly through electronic switch 127, automatic controller 128, oscillator 120, voltage control oscillation frequency (VCO) 129 and phase comparator 130 (refer to FIG. 8), of which phase comparator 130 is used to determine the phase difference of main electromagnetic coil 11 and oscillator 120.

For more information of the mouse pad 1 and its overall operating modes in the second example, refer to FIGS. 7 and 8. The oscillator 120 is composed of U2F, CX1 and RX1, and the oscillator frequency is driven by buffer U2E, subjected to predrive U2B, U2C, DP1, DN1, RP1, RN1, RW5, and finally to high-current drive QP1, QN1, RP2, RN2, DPQ1 and DPQ2. The above-mentioned elements constitute the drive 121, while CL1 and CL2 form the coupler 122. The electric energy of that frequency shall be coupled to L1 enameled wire to constitute the main electromagnetic coil 11 for single-way transmission of energy. Meanwhile, the single-way data is received through L1 and demodulated by the demodulator 123 consisting of D2, D3, C1, R2, C2 and R2A. The oscillation frequency of electromagnetic induction shall be filtered out. Next, C3, R3, R4, C4, C5, R5, D5 and D6 constitute a band-pass filter 124 in order to filter unnecessary spurious wave. As R6, R8, R9, R10, R11, R12 and U4B constitute a comparator 125, the output signal of band-pass filter can be compared and amplified to output the level required by a microprocessor. When firmware within U1 microprocessor and USB serial data transmission interface constitute a mouse data converter 126, the signal can be output to the computer via the file format of mouse. Moreover, U1 microprocessor is used to control LED1 and LED2 as part of display 15, so the users are aware of the state of battery-free wireless optical mouse. When wireless optical mouse 2 operates beyond the range of wireless optical mouse body 27, the automatic controller 128 enables U1 microprocessor to output a DC level, and controls the pulse width output by oscillator 120 via a comparator composed of U2A, RF4, RF5, ZD1, RF6, RF3, RF1, RF2, RF8 and EC5. In this way, it can reduce the energy of drive 121 for protection and lower power consumption. RX3, RX2, EC6, DC1 and CX2 constitute voltage control oscillation frequency (VCO) 129 while U2A, U2E, R31, C23, R25, D9, D10, R26, R27, C21, R28, U2C, R29, R30, C22, R24, R23, C20, R22, R21, U2D, D7, D8 and R20 form a phase comparator 130 incorporating main electromagnetic coil 11 output waveform and oscillator output waveform, so the energy output of main electromagnetic coil 11 can be controlled through the voltage generated by main electromagnetic coil 11 output waveform and the voltage-generated by the phase comparator 130 incorporating main electromagnetic coil 11 output waveform and oscillator output waveform along with voltage control oscillation frequency (VCO) 129. When the host computer 3 enters sleep mode, download sleep/operating mode via USB serial data transmission interface, or the users can activate keystroke 16 to enter sleep and wake-up mode by pressing S1, then U1 microprocessor will be cut off. Turn on power switch Q1, R40, R41, R42 and D1 to constitute the power switch 127, and turn it off. Then, switch on oscillating circuit, comparator 125 and automatic controller 128. In case oscillating circuit is switched off, there is little power consumption for the drive. Meanwhile, U1 microprocessor closes the display 15. Some necessary electronic components are included in the circuit herein.

As shown in FIG. 9, the oscillator 120 of the mouse pad 1 is composed of U4D, CX2, RX6, RX7, RX8 and RX9. The frequency eliminated by U2A is subjected to predrive U2B, DP1, DN1, RP1, RN1, RW1, RW2, RW3, RW5, and then to high-current drive QP1, QN1, RP2, RN2, DPQ1 and DPQ2. The above-mentioned elements constitute the drive 121, while CL1 and CL2 form the coupler 122. The electric energy of that frequency shall be coupled to L1 enamelled wire to constitute the main electromagnetic coil 11 for single-way transmission of energy. Meanwhile, the single-way data is received through L1 and demodulated by the demodulator 123 composed of D2, D3, C1, R2, C2 and R2A. The oscillation frequency of electromagnetic induction shall be filtered out. Next, C3, R3, R4, C4, C5, R5, D5 and D6 constitute a band-pass filter 124 in order to filter unnecessary spurious wave. As R6, R8, R9, R10, R11, R12 and U4B constitute a comparator 125, the output signal of band-pass filter can be compared and amplified to output the level required by a microprocessor. When firmware within U1 microprocessor and USB serial data transmission interface constitute a mouse data converter 126, the signal can be output to the computer via the file format of mouse. Moreover, U1 microprocessor is used to control LED1 and LED2 as part of display 15, so the users are aware of the state of battery-free wireless optical mouse. When wireless optical mouse 2 operates beyond the range of wireless optical mouse body 27, the automatic controller 128 shall, via the output current of coil L1, control the pulse width output by oscillator 120 comprising U4A, RF4, RF5, RF6, RF1, RF2, CF1, RF7, RF8, EC5, RF9, RF10, RW3, Q2. In this way, it can reduce the energy of drive 121 for protection and lower power consumption. When S1 of keystroke 16 is pressed, mouse data processor 126 will generate a voltage to control voltage control oscillation frequency (VCO) 129 composed of RX1, RX2, RX3, RX4, RX5, CX1, thereby helping change oscillation frequency and control the output energy of main electromagnetic coil 11. The energy of coil within automatic controller 128 shall be detected and output, and the current output by coil L1 is channeled to achieve the energy level of main electromagnetic coil 11 via U4A, RF4, RF5, RF6, RF1, RF2, CF1, RF7, RF8 and EC5. Next, this energy level shall be output to the mouse data processor 126, which can generate a DC voltage or pulse width modulation so as to form a DC current. Thus, it is possible to control the voltage control oscillation frequency (VCO) 129 composed of RX1, RX2, RX3, RX4, RX5, CX1, thereby helping change oscillation frequency and control the optimum energy output by main electromagnetic coil 11. When the host computer 3 enters sleep mode, download sleep/operating mode via USB serial data transmission interface, or the users can activate the operating mode by pressing S1 keystroke 16, then U1 microprocessor will be cut off. Turn on power switch Q1, R40, R41, R42 and D1 to constitute the power switch 127, and turn it off. Then, switch on oscillating circuit, comparator 125 and automatic controller 128. In case oscillating circuit is switched off, there is little power consumption for the drive. Meanwhile, U1 microprocessor closes the display 15. Some necessary electronic components are also included in the circuit herein.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A battery-free wireless optical mouse, which generally comprises a wireless optical mouse and a mouse pad, includes the following features: the wireless optical mouse is equipped with a mouse electromagnetic coil, a coupler, a circuit rectifier, a circuit voltage stabilizer, a mouse controller, an photo sensing displacement data generator, a circuit modulator, a roller signal generator and a keystroke. The mouse pad is provided with a main electromagnetic coil, an oscillator, a drive, a coupler, a demodulator, a band-pass filter (BPF), a comparator, an electronic switch, an automatic controller and mouse data processor, of which the mouse electromagnetic coil's coupler obtains electric energy from main electromagnetic coil. After being rectified by circuit rectifier and regulated by voltage stabilizer, the electric energy can achieve the power supply required for the operation of wireless optical mouse. Also, when main electromagnetic coil is coupled to the wireless optical mouse, the operating and status information shall be encoded by mouse controller and then transmitted by means of electromagnetic induction after modulation or load modulation by circuit modulator. The data shall be output to the mouse data processor via demodulator, band-pass filter (BPF) and comparator, then decoded and transmitted to the computer after being converted into the format required by the computer.

2. A battery-free wireless optical mouse as defined in claim 1, which will send out status information during operation, whereby the mouse data processor can control the electromagnetic energy output by main electromagnetic coil.

3. A battery-free wireless optical mouse as defined in claim 1, if the mouse data processor has not received data from wireless optical mouse after a preset time limit, the main electromagnetic coil will be controlled to output a preset minimum electromagnetic energy.

4. A battery-free wireless optical mouse as defined in claim 1, The mouse pad includes a display unit for the operating status of wireless optical mouse.

5. A battery-free wireless optical mouse as defined in claim 4, the display unit of mouse pad is a LED.

6. A battery-free wireless optical mouse as defined in claim 1, the oscillation frequency of circuit oscillator within the mouse pad can be replaced by the output of mouse data converter.

7. A battery-free wireless optical mouse as defined in claim 1, the mouse data processor is either a microprocessor incorporating computers data transmission interface or a tailor-made integrated circuit.

8. A battery-free wireless optical mouse as defined in claim 1, the electronic switch is applied for on/off of oscillator.

9. A battery-free wireless optical mouse as defined in claim 8, the electronic switch's oscillation frequency is output or otherwise not output by a mouse data converter.

10. A battery-free wireless optical mouse as defined in claim 1, the mouse pad includes a keystroke used for wake-up or sleep and wake-up of the mouse pad.

11. A battery-free wireless optical mouse as defined in claim 1, compatible with USB or PS2 interface for the data transmission interface of the mouse data processor, the power supply of mouse pad can be achieved from USB or PS2.

12. A battery-free wireless optical mouse as defined in claim 1, in addition to power supply accessible from USB or PS2, the mouse pad can also be equipped with a power socket or an external power supply for necessary electric energy.

13. A battery-free wireless optical mouse as defined in claim 1, the automatic controller is applied to limit the max. output electromagnetic energy of main electromagnetic coil.

14. A battery-free wireless optical mouse as defined in claim 1, the mouse pad and its main electromagnetic coil can be separated from the electronic unit of mouse pad.

15. A battery-free wireless optical mouse as defined in claim 2 or 3, where either analog or digital mode is used to control the output electromagnetic energy of main electromagnetic coil.

16. A battery-free wireless optical mouse as defined in claim 15, the digital is suitable for pulse width modulation.

17. A battery-free wireless optical mouse as defined in claim 15, the digital is suitable for frequency modulation.

18. A battery-free wireless optical mouse as defined in claim 15, the digital is suitable for variable-frequency pulse width modulation.

19. A battery-free wireless optical mouse as defined in claim 1, the mouse controller can transmit preset data within every preset time limit during its operation.

20. A battery-free wireless optical mouse as defined in claim 1, the main electromagnetic coil is equipped with an adjustable inductor for control of its output energy.

21. A battery-free wireless optical mouse as defined in claim 1, the wireless optical mouse is also equipped with a low-voltage reset unit, which is used to detect the power supply/voltage level, reset the mouse controller and photo sensing displacement signal generator. Alternatively, it can firstly reset the mouse controller, which, then, reset the photo sensing displacement signal generator.

22. A battery-free wireless optical mouse as defined in claim 21, the low-voltage reset unit can be applied to reset the mouse controller and photo sensing displacement unit as a two-section low-voltage reset unit.

23. A battery-free wireless optical mouse as defined in claim 1, the wireless optical mouse is provided with an over voltage current distributor, which is used to distribute the current from the over voltage energy circuit.

24. A battery-free wireless optical mouse generally comprises a wireless optical mouse and a mouse pad with its major features below: the wireless optical mouse is equipped with a mouse electromagnetic coil, and the mouse pad with a main electromagnetic coil, of which electromagnetic coil's electromagnetic coupler obtains electric energy from main electromagnetic coil. The wireless optical mouse is also provided with an over voltage circuit distributor, which is used to distribute the over voltage current from the energy circuit.

25. A battery-free wireless optical mouse as defined in claim 24, the over voltage circuit distributor is a Zener diode.

26. A battery-free wireless optical mouse generally comprises a wireless optical mouse and a mouse pad with its major features below: the wireless optical mouse is equipped with a mouse electromagnetic coil, and the mouse pad with a main electromagnetic coil, of which electromagnetic coil's electromagnetic coupler obtains electric energy from main electromagnetic coil. The mouse pad is provided with a voltage control oscillation frequency VCO to control the energy output of main electromagnetic coil.

27. A battery-free wireless optical mouse as defined in claim 26, a feedback mode is applied to the control of energy output of main electromagnetic coil.

28. A battery-free wireless optical mouse as defined in claim 26, the mouse pad is also provided with a phase comparator, which is used to determine the phase difference of main electromagnetic coil and oscillator so as to control the energy output of main electromagnetic coil.

29. A battery-free wireless optical mouse generally comprises a wireless optical mouse and a mouse pad with its major features below: the wireless optical mouse is equipped with a mouse electromagnetic coil, and the mouse pad with a main electromagnetic coil, of which electromagnetic coil's electromagnetic coupler obtains electric energy from main electromagnetic coil. The mouse pad consists of an oscillator, which is provided with an integral frequency eliminator to control the energy output of main electromagnetic coil. And, the frequency of oscillator is several times of the resonance frequency of main electromagnetic coil.

30. A battery-free wireless optical mouse generally comprises a wireless optical mouse and a mouse pad with its major features below: the wireless optical mouse is equipped with a mouse electromagnetic coil, and the mouse pad with a main electromagnetic coil, of which electromagnetic coil's electromagnetic coupler obtains electric energy from main electromagnetic coil. The wireless optical mouse is equipped with a detector and controller for the energy output of main electromagnetic coil.

31. A battery-free wireless optical mouse as defined in claim 30, the detector for the energy output of main electromagnetic coil serves as a resistor unit to detect the output current of main electromagnetic coil.

32. A battery-free wireless optical mouse as defined in claim 30, the mouse pad is also equipped with a data processor, which is used to control the energy output of main electromagnetic coil.

33. A battery-free wireless optical mouse as defined in claim 30, the controller for the energy output of main electromagnetic coil comprises an oscillator and a set of resistor and capacitor for control of the oscillator.
